(19) United States
(12) Patent Application Publication
(10) Pub. No.: US 2006/0157498 A1
(43) Pub. Date: Jul. 20, 2006

(54) Vendor with agitating device

(76) Inventor: Shen-Hao Yao, Kao Hsiung (TW)

Correspondence Address: SHEN-HAO YAO, 235 Chung - Ho, Box 8-24, Taipei, TW

(21) Appl. No.: 10/989,853

(22) Filed: Nov. 15, 2004

(51) Int. Cl. G07F 11/00; B65H 3/60; B65G 59/00

(52) U.S. Cl. 221/200; 221/203; 221/264

(57) ABSTRACT

The device comprises: a body having a transfer tube at a lower side thereof; one end of the transfer tube being connected to an outlet at a bottom of the body; a receiving section being formed at an upper side of the body; a groove formed within the body; a bottom of the groove being formed a merchandise output hole; the merchandise output hole being connected to another end of the transfer tube; a rotary disk being installed in the groove; the rotary disk having a plurality of holes; an agitating rod being placed at an upper center of the rotary disk; the rotary disk being rotatable by using a motor to drive the rotary disk so that the rotary disk rotating in the groove; an agitating unit being installed in the receiving section of the body. The agitating unit includes a transmission, a first linkage and a second linkage.

### FIELD OF THE INVENTION

The present invention relates to vendors, and particularly to a vendor agitating device, which can make merchandises being outputted easily and successfully.

### BACKGROUND OF THE INVENTION

With reference to FIG. 1, a prior art vendor is illustrated. The vendor is used to sell small volume objects or irregular shape objects. The merchandises are packed by ball shape packages and then are placed in the vendor.

Referring to FIG. 1, the prior art vendor has a body 10. The body 10 includes a groove 20. A rotary disk 30 is installed in the groove 20.

A transfer tube 11 is installed in the lower side of the body 10. The transfer tube 11 is connected to a merchandise outlet 12. An upper space of the body 10 has a transfer tube 11.

A bottom of the groove 20 is installed with an output hole 21 for outputting a merchandise 40. An inner diameter of the output hole 21 is approximately greater than an outer diameter of the merchandise 40. The output hole 21 is connected to the transfer tube 11 of the body 10.

The rotary disk 30 has a plurality of receiving holes 31 for receiving merchandises 40. An inner diameter of each receiving hole 31 is approximately greater than that of the merchandise 40. An upper center of the rotary disk 30 is an elastic strip-like movable rod 32. A motor serves to drive the rotary disk 30 to rotate on the groove 20.

By above structure, in the prior art, rotations of the rotary disk 30 will cause that the merchandise 40 in the receiving hole 31 of the rotary disk 30 to fall down to the output hole 21 of the groove 20 so as to output the merchandise 40 to the outlet 12 at the bottom of the body 10 so as to output the merchandise 40.

However the prior art has still some defects. For example, merchandises 40 will be buckled on the wall of the receiving section 13 (referring to FIG. 2) so that the merchandises 40 are accumulated on the receiving section 13. As a result, the movable rod 32 cannot touch the merchandise 40 so that the merchandise 40 cannot fall into the receiving hole 31 of the rotary disk 30.

### SUMMARY OF THE INVENTION

Accordingly, the primary object of the present invention is to provide a vendor agitating device which can improve the defects in the prior art.

To achieve above objects, the present invention provides a vendor with an agitating device. The device comprises: a body having a transfer tube at a lower side thereof; one end of the transfer tube being connected to a merchandise outlet at a bottom of the body; a receiving section being formed at an upper side of the body; a groove formed within the body; a bottom of the groove being formed a merchandise output hole; the merchandise output hole being connected to another end of the transfer tube; a rotary disk being installed in the groove; the rotary disk having a plurality of holes; an agitating rod being placed at an upper center of the rotary disk; the rotary disk being rotatable by using a motor to drive the rotary disk so that the rotary disk rotating in the groove; an agitating unit being installed in the receiving section of the body; the agitating unit including a transmission, a first linkage and a second linkage; the transmission being fixed to a wall of the body by a supporting sheet; a power output end of the transmission being fixed to one end of a driven sheet; another end of the driven sheet being movably connected to one end of the first linkage; another end of the first linkage being movably connected to one end of the second linkage; another end of the second linkage being movably connected to the wall of the body.

The various objects and advantages of the present invention will be more readily understood from the following detailed description when read in conjunction with the appended drawing.

### BRIEF DESCRIPTION OF THE DRAWINGS

FIG. 1 is a structural schematic view of a prior art vendor.

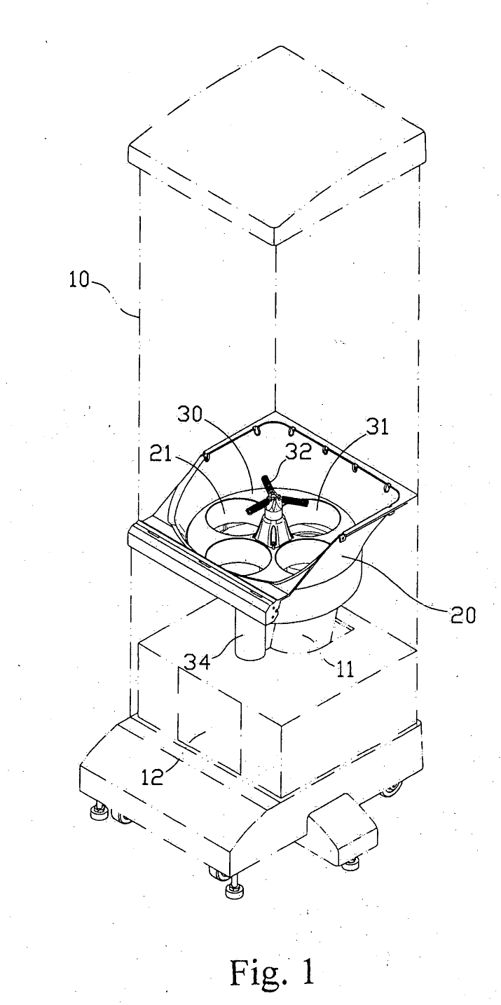

FIG. 2 is a lateral view and a schematic view of a vendor.

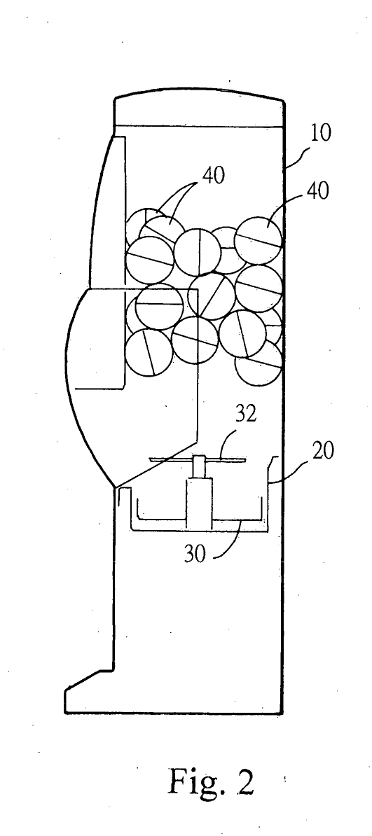

FIG. 3 is a lateral view of the vendor of the present invention.

FIG. 4 is a perspective view of the agitating device of the present invention.

FIG. 5 is a schematic view showing the operation of the agitating unit of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

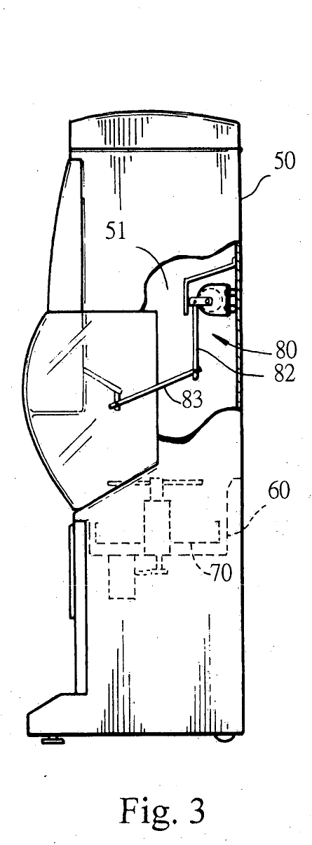

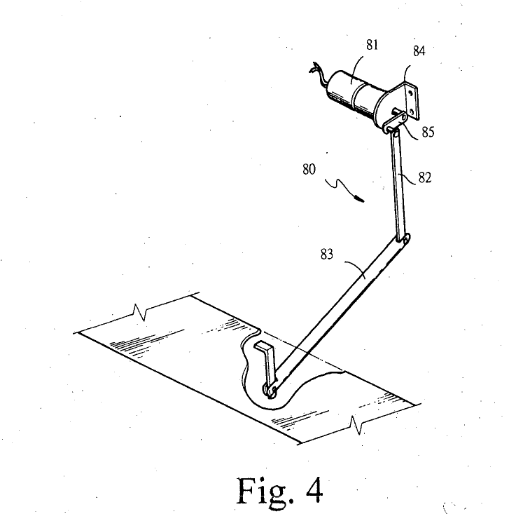

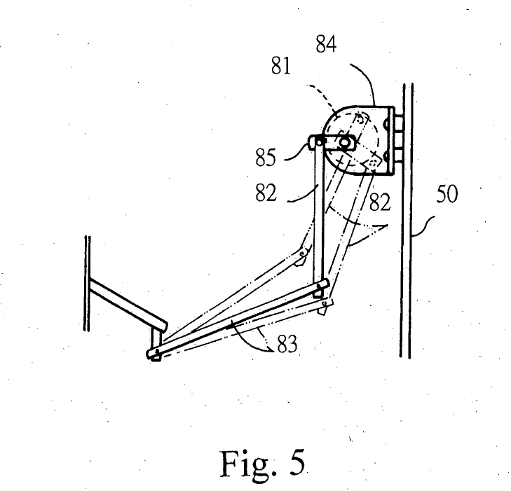

With reference to FIGS. 3 to 5, the present invention will be described herein. The vendor agitating device of the present invention has the following elements.

A body 50 has a transfer tube at a lower side thereof. One end of the transfer tube is connected to a merchandise outlet at a bottom of the body 50. A receiving section 51 is formed at an upper side of the body 50.

A groove 60 is formed within the body 50. A bottom of the groove 60 is formed a merchandise output hole. The merchandise output hole is connected to another end of the transfer tube.

A rotary disk 70 is installed in the groove 60. The rotary disk 70 has a plurality of holes. An agitating rod is placed at an upper center of the rotary disk 70. The rotary disk 70 is rotatable by using a motor to drive the rotary disk 70 so that the rotary disk 70 rotates in the groove 60.

An agitating unit 80 is installed in the receiving section 51 of the body 50. The agitating unit 80 includes a transmission 81, a first linkage 82 and a second linkage 83.

The transmission 81 is fixed to a wall of the body 50 by a supporting sheet 84. A power output end of the transmission is fixed to one end of a driven sheet 85. Another end of the driven sheet 85 is movably connected to one end of the first linkage 82. Another end of the first linkage 82 is movably connected to one end of the second linkage 83. Another end of the second linkage 83 is movably connected to the wall of the body. Thereby the transmission 81 can drive the driven sheet 85 to rotate. Then the first linkage 82 and second linkage 83 are reciprocally moved upwards and downwards for being taken out. Especially, by the agitating unit 80, the first linkage 82 and second linkage 83 will reciprocally move upwards and downwards so that the merchandises on the receiving section 51 will not be buckled to a wall of the body 50. Thereby the merchandise can fall to the merchandise receiving holes of the rotary disk 70 successfully for output.

By above mentioned structure, when a merchandise is outputted, by rotating the rotary disk 70, the merchandise falling upon the hole of the rotary disk 70 will be driven to be on the merchandise output hole of the groove 60. Then the merchandise falls down to be guided by the transfer tube to the merchandise outlet at the bottom of the body 50.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vendor with an agitating device comprising:
a body having a transfer tube at a lower side thereof; one end of the transfer tube being connected to a merchandise outlet at a bottom of the body; a receiving section being formed at an upper side of the body;
a groove formed within the body; a bottom of the groove being formed with a merchandise output hole; the merchandise output hole being connected to another end of the transfer tube;
a rotary disk being installed in the groove; the rotary disk having a plurality of holes; an agitating rod being placed at an upper center of the rotary disk; the rotary disk being rotatable by using a motor to drive the rotary disk so that the rotary disk rotating in the groove;
an agitating unit being installed in the receiving section of the body;
the agitating unit including a transmission, a first linkage and a second linkage;
the transmission being fixed to a wall of the body by a supporting sheet; a power output end of the transmission being fixed to one end of a driven sheet; another end of the driven sheet being movably connected to one end of the first linkage; another end of the first linkage being movably connected to one end of the second linkage; another end of the second linkage being movably connected to the wall of the body;
wherein the transmission can drive the driven sheet to rotate; then the first linkage and second linkage are reciprocally moved upwards and downwards; by the agitating unit, the first linkage and second linkage will reciprocally moves upwards and downwards so that the merchandises on the receiving section will not be buckled to a wall of the body.
